(19) United States
(12) Patent Application Publication
(10) Pub. No.: US 2016/0118077 A1
(43) Pub. Date: Apr. 28, 2016

(54) OPTICAL TAPE DATA STORAGE

(71) Applicants: Barry M. Lunt, Provo, UT (US); Matthew R. Linford, Provo, UT (US); Robert C. Davis, Provo, UT (US)

(72) Inventors: Barry M. Lunt, Provo, UT (US); Matthew R. Linford, Provo, UT (US); Robert C. Davis, Provo, UT (US)

(21) Appl. No.: 14/522,349

(22) Filed: Oct. 23, 2014

(51) Int. Cl. G11B 7/2433; G11B 7/135; G11B 7/2437

(52) U.S. Cl. CPC G11B 7/2433; G11B 7/2437; G11B 7/135; G11B 2007/24312

(57) ABSTRACT

An optical tape data storage is disclosed. An optical tape includes a substrate in a linear thin film shape and a recording layer deposited on the substrate. An irreversible optically detectable change is formed in the recording layer upon application of energy to the recording layer such that data is recorded on the recording layer by forming optically detectable changes. The recording layer may comprise a metal, a metal alloy, a metal oxide, a metalloid, or any combination thereof. The optical tape may further include an adhesion promotion layer for improving adhesion of the recording layer and the substrate, a reflective layer for providing optical contrast to an adjacent layer, and/or an absorptive layer positioned adjacent to the recording layer to absorb ablatable material not entirely ablated during ablation.

### TECHNICAL FIELD

This application is related to long-term data storage. More particularly, this application is related to optical tape data storage.

### BACKGROUND

Magnetic tape-based data storage has been used widely to store digital information. Digital information is usually stored in a binary form magnetically on a tape. Since large amounts of data can be stored in a relatively small space with the magnetic tape-based data storage, it has been used as a bulk storage means for operation with digital computers and the like.

FIG. 1 shows a sectional view of the magnetic tape 100 used in conventional magnetic tape-based data storage. The magnetic tape 100 comprises a polyethylene terephthalate (PET) substrate 102 (so-called Mylar substrate), a magnetic recording layer 104, and a lubricant layer 106. The data is magnetically recorded in the recording layer 104 with a magnetic recording head, which is in contact with the lubricant layer 106 of the tape 100. In heat-assisted magnetic recording (HAMR), the magnetic recording head is assisted by a laser to heat the recording layer. HAMR takes advantage of high-stability magnetic compounds such as iron platinum alloy. The recording layer materials can store information bits in a much smaller area by heating the materials before applying the changes in magnetic orientation.

The magnetic tape-based data storage has been a widely-adopted format for archival solutions. However, the main disadvantages of the conventional magnetic tape-based storage are up-front costs of the drive and the media and the lack of permanence of the data. Because the magnetic tape is reversible, the magnetic tape-based data storage is inherently non-permanent, although it is among the most long-lasting data storage means currently available in data storage technologies.

### SUMMARY

In accordance with one embodiment, there is provided an optical tape for storing data. An optical tape includes a substrate in a linear thin film shape, and a recording layer deposited on the substrate. An optically detectable change may be formed in the recording layer by applying energy to the recording layer such that data is recorded on the recording layer by forming optically detectable changes.

The material used for the recording layer may be substantially inert to oxidation and has a melting point of about 200° C. to about 1,000° C. when in the form of either (a) bulk form, (b) a thin film, and/or (c) a porous or a particulate film. After exposure of the bulk material of the recording layer to air at 220° C. for 48 hours, either (a) an oxide layer does not form on the bulk material, or (b) an oxide layer forms on the bulk material that is no more than a predetermined thickness.

The recording layer may comprise a metal, a metal alloy, a metal oxide, a metalloid, or any combination thereof. For example, the recording layer may comprise a Tellurium, Selenium, Bismuth (TSB) layer sandwiched between two carbon layers. Alternatively, the recording layer may comprise AuSn alloy, AuSi alloy, AuGe alloy, AuIn alloy, CrO, CrO₂, VO₂, or a combination thereof. Alternatively or additionally, the recording layer may comprise at least one dopant.

Alternatively or additionally, the optical tape may further include an adhesion promotion layer for improving adhesion of the recording layer and the substrate. Alternatively or additionally, the optical tape may further comprise a reflective layer for providing optical contrast to an adjacent layer. Alternatively or additionally, the optical tape may further comprise an absorptive layer positioned adjacent to the recording layer to absorb ablatable material not entirely ablated during ablation.

In accordance with another embodiment, there is provided an optical tape storage device. An optical tape storage device comprises an optical pickup device for optically writing data on, and/or reading data from, an optical tape and a tape drive for driving the optical tape in a forward direction or a backward direction between a first reel and a second reel while the optical tape passes the optical pickup device. The data is optically stored on a recording layer of the optical tape by forming optically detectable changes in the recording layer by applying energy to the recording layer.

In accordance with another embodiment, there is provided a method of recording data on an optical tape. An optical tape is provided for recording data on a recording layer of the optical tape, wherein the optical tape includes at least one substrate in a linear thin film shape and at least one recording layer deposited on the substrate. Data to be recorded is received. The data is then recorded on the recording layer of the optical tape by applying energy to the recording layer to cause an irreversible and optically detectable change in the recording layer.

### BRIEF DESCRIPTION OF THE DRAWINGS

The following figures form part of the present specification and are included to further demonstrate certain aspects of the invention. The invention may be better understood by reference to one or more of these figures in combination with the detailed description of specific embodiments presented herein.

FIG. 1 shows a sectional view of the magnetic tape used in conventional magnetic tape-based data storage.

FIG. 2A shows a sectional view of an example optical tape for storing data in accordance with one embodiment.

FIG. 2B shows a sectional view of an example optical tape with holes formed in the recording layer to store information.

FIGS. 2C-2E show a sectional view of an example optical tape for storing data in accordance with another embodiment.

FIG. 3 depicts an optical tape in accordance with another embodiment.

FIG. 4 illustrates an example optical tape drive in accordance with one embodiment.

FIG. 5 shows an example optical pickup that may be used for reading or writing information from and to the optical tape.

FIG. 6 shows an example process of recording data on the optical tape in accordance with one embodiment.

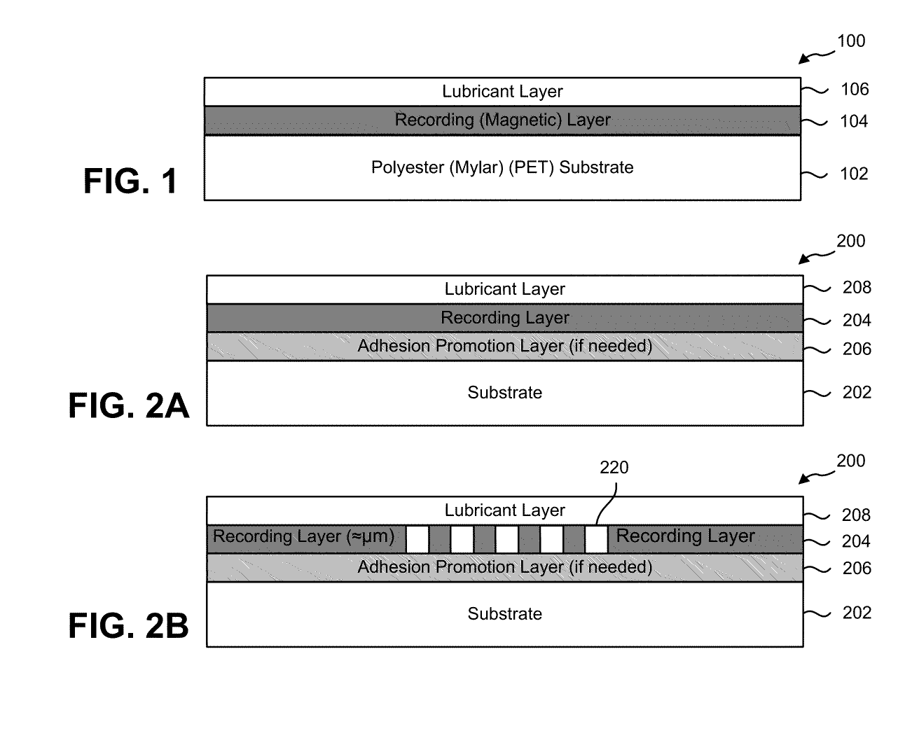

### DETAILED DESCRIPTION

The optical tape data storage in accordance with embodiments disclosed herein would solve the problem of permanence. The longevity of the data stored in the optical tape data storage in accordance with the embodiments could be about 1,000 years.

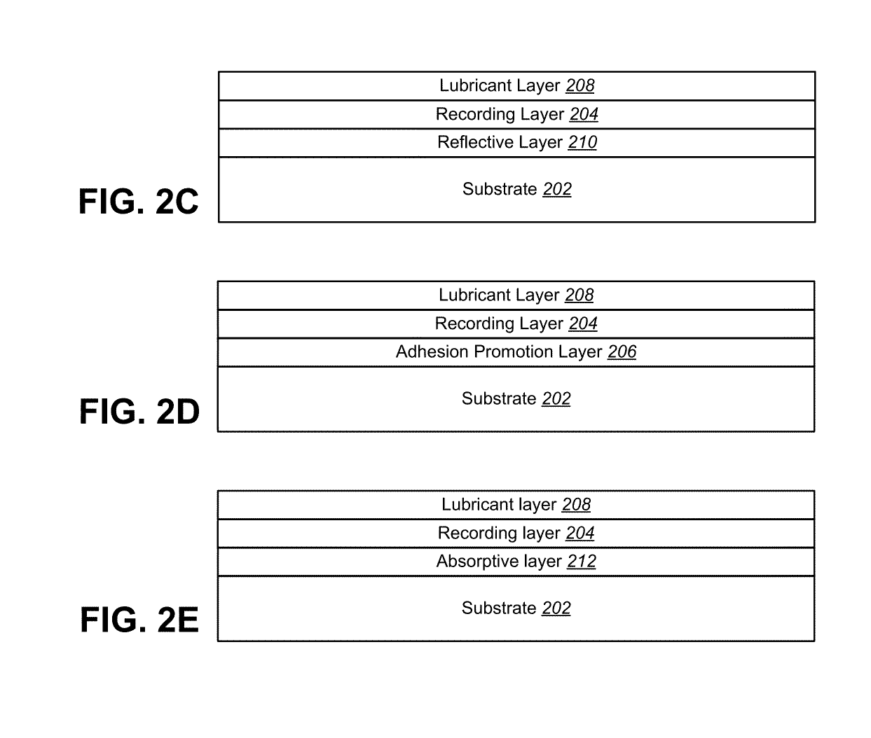

FIG. 2A shows a sectional view of the optical tape for storing data in accordance with one embodiment. The optical tape 200 includes a substrate 202 and a recording layer 204. The optical tape 200 may further include an adhesion promotion layer 206 between the substrate 202 and the recording layer 204. The optical tape 200 may optionally include a lubricant layer 208. Alternatively, the lubricant could be dispersed within the recording layer, as is sometimes done in present magnetic tape media.

The optical tape 200 is in a linear thin film shape similar to the conventional magnetic tape. The optical tape 200 may use any conventional tape widths and formats, such as the ½ inch formats, the 8 mm formats, the ¼ inch formats, or any other tape width or formats.

The substrate 202 may comprise materials that are not subject in any substantial way to age degradation effects. The substrate 202 may be any material compatible with use in optical information storage. For example, the substrate 202 may be polyethylene terephthalate (PET) substrate or any other polyester films. Other plastics or polymers may also be used. The substrate 202 may be any thickness. For example, the substrate thickness may be 0.03 mm.

The recording layer 204 comprises one or more layers of material suitable for optically storing information. The recording layer 204 can generally be any thickness. For example, the recording layer 204 may be 50 nm. The materials of the recording layer 204 and manufacturing process of the optical tape 200 are designed to be very durable and not subject to age-degradation effects to a substantial degree. The information writing process on the recording layer 204 is intended to be permanent and not subject to age degradation effects to a substantial degree.

The recording layer material is substantially inert to oxidation and may have a melting point of about 200° C. to about 1,000° C. when in the form of either (a) bulk form, (b) a thin film (e.g., 50 nm), and/or (c) a porous or a particulate film. This melting point range may be needed as these temperatures can be readily achieved using a laser source.

The phrase “substantially inert to oxidation” means that after exposure of the bulk material to air at 220° C. for 48 hours, either (a) an oxide layer does not form on the bulk material, or (b) an oxide layer forms on the bulk material that is no more than a certain thickness (e.g., 30 nm, 20 nm, 15 nm, 10 nm, 8 nm, 6 nm, 5 nm, 4 nm, 3 nm, 2 nm, 1 nm, or no oxide layer). This oxide layer may have irregularities in it as a result of defects in the film that are present because of the method in which it is deposited.

The recording layer material may be a metal, a metal alloy, a metal oxide, a metalloid, or any combination of these material types. For example, the recording layer 204 may comprise a Tellurium, Selenium, Bismuth (TSB) layer sandwiched between two carbon layers. A carbon layer may be deposited on top of the substrate 202, and the TSB layer may be deposited on top of the carbon layer and another carbon layer may be deposited on top of the TSB layer. The alloy of TSB is designed to remain physically and optically stable for a very long time, meaning it does not further oxidize nor change in its crystallinity nor morphology.

Other examples of the recording layer material include AuSn alloys (bulk melting point between 278° C. and 1064° C., depending on the percentage Sn content), AuSi alloys (bulk melting point between 363° C. and 1064° C., depending on the percentage Si content), AuGe alloys (bulk melting point between 300° C. and 1064° C., depending on the percentage Ge content), AuIn alloys (485° C. bulk melting point), CrO (197° C. bulk melting point), CrO₂ (400° C. bulk decomposition point), and VO2 (1967° C. bulk melting point, 400° C. thin film melting point).

The recording layer 204 may further comprise at least one dopant. The dopant can be used to modulate or modify the thermal, optical, and stability profile of the recording layer material. Alternatively or additionally, the dopant can be used to modify the asymmetry of the readout signal when reading the marks.

FIG. 2B shows a sectional view of the optical tape 200 with holes 220 formed in the recording layer 204 to store information. The recording layer 204 may provide a high optical contrast between written and unwritten portions. For example, the unwritten recording portions may have either a high optical reflectivity or a low optical reflectivity. Materials having small bandgaps of less than or equal to about 1.5 eV may be used due to their high optical contrast.

In one embodiment, the recording layer material is ablatable material and data may be written into the recording layer 204 by ablating portions of the recording layer 204. Ablation is a process of instantaneously applying a sufficient amount of energy to an object that the object's ablatable material is removed. The ablated material may be evaporated into a gas. Alternatively, the ablated material may leave the recording layer in the form of particles. The evaporative changes made to the ablatable material of the recording layer 204 are more permanent in nature and are not likely to rapidly degrade over time. It should be noted that the term “instantaneously” is used to imply that the process is performed quickly, but should not be limited to any certain amount of time. Furthermore, the term “permanent,” as used herein, implies exceptional robustness, durability and a lack of any tendency to degrade, and is not intended to imply infinite permanence.

The amount of energy required to instantaneously raise the temperature of an ablatable material will vary greatly depending on the material. For example, glassy carbon is a carbon structure with multiple tightly bound carbon-carbon double bonds, which give glassy carbon absorptive properties advantageous for ablation. Other materials will similarly be more or less suited to ablation. Another measure used in the process of ablation is the amount of energy used to exact the change. This measurement will be referred to herein as ablation energy. It should be noted that complete ablation may not be necessary. In some cases, partial ablation of the ablatable material may be sufficient. In other words, ablation may be considered complete even though some ablatable material remains at the point of ablation. The same is true of the reflective layer, as will be explained below. In some cases, the reflective layer need only reflect a portion of the ablation energy to be successful.

In some embodiments, the ablation energy may be measured as a unit of energy per unit volume of material. For example, thicker layers of ablatable material may require a greater amount of energy to ablate. Other materials may also be more or less likely to ablate, depending on the type of material and other conditions. Many factors affect both the desired temperature and the desired energy level. Other factors may also be varied to aid in ablation such as exposure time or wavelength of the energy source. For example, different wavelengths may be used to match the properties of the ablative layer such that ablation occurs more readily. In some cases, a thicker layer of material may necessitate a longer or more intense exposure to ablation energy. Still other factors may include ambient temperature, humidity, the process by which the ablatable material was formed, the process by which the ablatable material was bonded to other materials in the ablatable media item, the type of ablation energy used in the process and the type and thickness of the reflective layer (when present). In some cases, measurements for exposure times, ablation energies and optimal thicknesses for any given ablatable layer and/or reflective layer are based on the type of material, thermal conductivity of the material, the surrounding environment and the amount of energy being imparted.

One of the deciding factors that determines whether ablation can occur or not is the total energy absorbed per unit surface area/volume of material that is being ablated. In some embodiments, it may be possible to use a conventional compact disc (CD) or digital versatile disc (DVD) or Blu-ray disc (BD) writer by adjusting exposure time and/or increasing the laser energy. The imparted energy should be sufficient to ablate the material in a particular portion of the media. The ablation process produces a permanent change in the ablated material and is highly robust against many forms of degradation.

Referring again to FIG. 2A, the adhesion promotion layer 206 may be provided to improve adhesion of the recording layer 204 and the substrate 202, or between any other layer(s). The use of the adhesion promotion layer 206 depends on the type of material used for the substrate 202 and the recording layer 204. The material used in the adhesion promotion layer 206 may include any type of natural or synthetic materials, including metals, alloys, polymers, copolymers, ceramics, or organic small-molecules, or adhesives including any type of drying, contact, hot melt, light curing, reactive, pressure sensitive or other adhesives. For example, a Cr layer may be used as the adhesion promotion layer for a recording layer of Au alloy.

The lubricant layer 208 may be optionally provided to prevent the recording layer 204 from being scratched or otherwise damaged.

The layers in the optical tape 200 may be applied or bonded using some type of thin film deposition. Thin film deposition encompasses multiple methods of applying material to an object including sputtering, electron beam evaporation, plasma polymerization, chemical vapor deposition, spin-coating, dip-coating, evaporative deposition, electron beam physical vapor deposition, sputter deposition, pulsed laser deposition, ion beam assisted deposition, electroplating, molecular beam epitaxy, atomic layer deposition, or any other thin-film or thick-film deposition technique. In some cases, each layer may be applied subsequently, or in other cases, previously bonded layers may be applied to other (previously-bonded) layers. Deposition may take place in a roll-to-roll manner.

Alternatively, a layer may be spin-coated onto a substrate and then caused to polymerize (cure) using UV light. Alternatively, a layer may be organically grown using various biological agents, and characteristics of a layer may be altered at a certain depth, thereby effectively forming a layer. Alternatively, magnetic nanoparticles may be applied to one or more of the layers such that a magnetic field could draw them to one side, thereby generating a sufficient gradient that, in effect, forms a layer. Other methods for creating and/or applying layers to an ablatable media may also be used.

FIGS. 2C and 2D show a sectional view of an example optical tape for storing data in accordance with another embodiment. The optical tape 200 may further include a reflective layer 210 between the substrate 202 and the recording layer 204.

The reflective layer 210 provides proper optical contrast between layers such that data can be read from the media. For example, when a laser used to read digital data hits the data portion of the media, the energy will be absorbed and little to no energy will be reflected. However, when the laser hits the reflective layer, the energy will be reflected and read as a reflection (corresponding to a digital ‘1’ or ‘0’). In other cases, an appropriate optical contrast may be provided without a reflective layer using various types of chemicals or other materials to generate a gradient effect that enhances the optical contrast.

In some cases, when sufficient optical contrast exists between the recording layer 204 and any adjacent layer, a reflective layer may or may not be included as a part of the optical tape 200 (as shown in FIGS. 2A and 2B). For example, if sufficient optical contrast exists between the recording layer 204 and the substrate 202, a reflective layer may not be necessary for data to be read from and written to the optical tape 200.

In some embodiments, a reflective layer 210 may be used to ensure that the ablation energy does not get transferred to any layers beyond the reflective layer 210. In such cases, the energy beam would ablate the material in the recording layer 204 and, once the beam reaches the reflective layer 210, the beam would be reflected and thus not travel beyond the reflective layer 210. Detecting that an energy beam has reached a reflective layer and reflected off of it may be accomplished using a photodiode or other energy detecting mechanism.

The reflective layer 210 may comprise a single material or a combination of materials. For example, the reflective layer 210 may comprise titanium or chromium. The titanium or chromium may be vapor deposited or sputtered onto the substrate.

FIG. 2C shows that the reflective layer 210 is deposited on the substrate 202 without an adhesion promotion layer. Alternatively, the adhesion promotion layer 206 may be deposited between the reflective layer 210 and the substrate 202 as shown in FIG. 2D.

The reflective layer 210 and the adhesion promotion layer 206 may be combined in some embodiments. For example, in FIG. 2C, the reflective layer 210 is positioned between the substrate 202 and the recording layer 204 and may act as both a reflective layer that reflects energy from an energy source (e.g., a laser diode) and as an adhesion layer that adheres the two adjacent layers. Thus, in some embodiments, the use of an adhesion promotion layer is dependent on the type of reflective layer used or whether a reflective layer has been used.

The optical tape 200 may include an absorptive layer 212 adjacent to the recording layer 204 as shown in FIG. 2E. The absorptive layer 212 may be added to absorb ablatable material that is not entirely ablated during the ablation process. For example, when an energy source such as a laser diode is focused on one portion of the recording layer 204, all or a part of the ablatable material will be ablated at that point. Any material not entirely ablated may then be absorbed by the absorptive layer 212. In some embodiments, it may be advantageous to use a low density material with a stiff, foamed structure that allows remaining ablatable material to be absorbed. Examples of such materials include foamed nickel or Aspen Aerogel™.

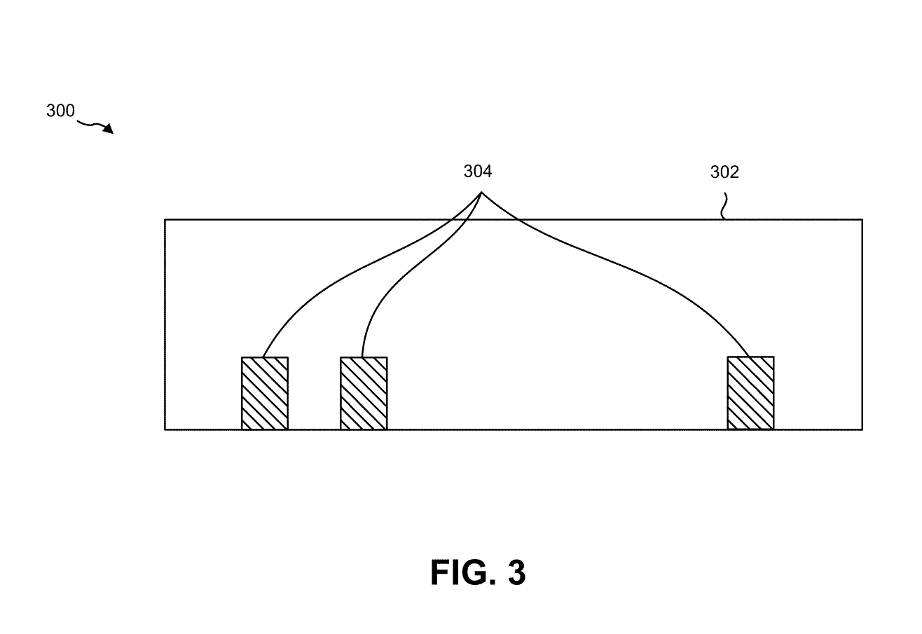

FIG. 3 depicts an optical tape 300 in accordance with another embodiment. The optical tape 300 may comprise a single layer 302 with one or more materials configured to provide an appropriate rigidity for the optical tape and to provide ablatability such that one or more portions of the layer 302 correspond to data points that have been subject to ablation. In one embodiment, the data points 304 may not proceed through the entire layer 302. Instead the data points 304 may occupy a small portion of the total thickness of the layer 302. The ablation depth of the data points 304 in FIG. 3 is relative and can be changed to be deeper or shallower, depending on the material used and/or the energy used for ablation.

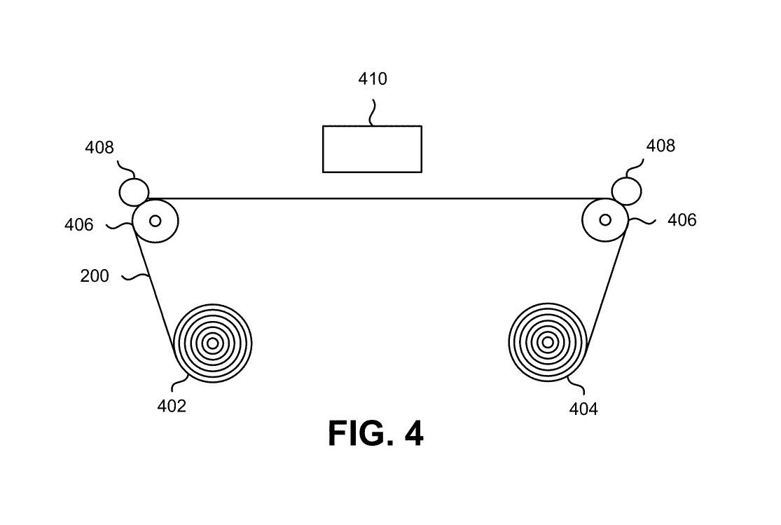

FIG. 4 illustrates an example optical tape drive 400 in accordance with one embodiment. The optical tape drive 400 may include a supply reel 402, a take-up reel 404, capstans 406, rollers 408, and an optical pickup 410. A tape driving means (not shown) drives the optical tape 200 in a forward direction or a backward direction between the supply reel 402 and the take-up reel 404 while the optical tape 200 passes the optical pickup 410.

The optical pickup 410 is an optical component including a laser beam source(s), such as a laser diode(s). The optical pickup 410 is used for reading information from, and recording information on, the optical tape 200. The optical pickup 410 may be the same as, or similar to, the conventional optical pickups used in a CD, DVD, or BD.

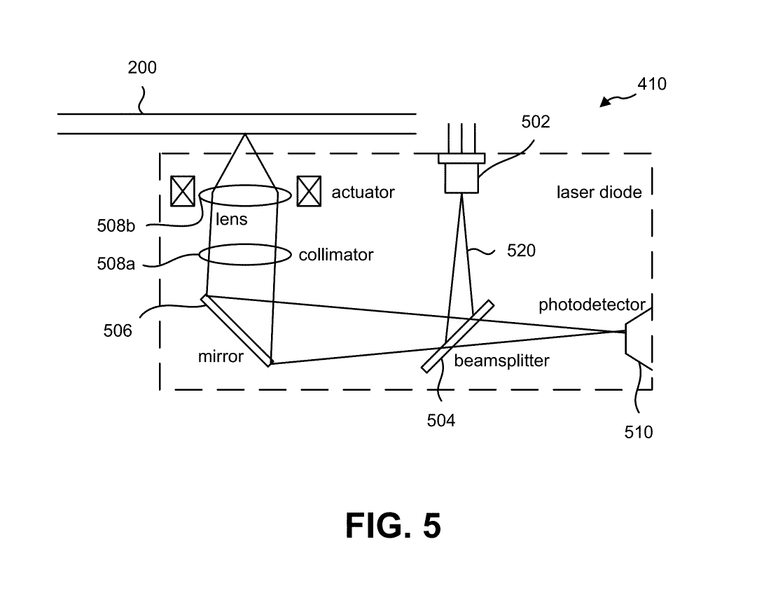

FIG. 5 shows an example optical pickup 410 that may be used for reading or writing information from and to the optical tape 200. In the optical pickup 410, laser beams 520 are emitted from the laser diode 502 and arrive at the surface of the recording layer of the optical tape 200 via various optical components, such as a beam splitter 504, a mirror 506, and a set of lenses 508a, 508b. The laser beams 520 that arrive at the recording layer of the optical tape 200 return to the optical pickup 410 and the reflected beams are detected by a photo detector 510. The detected signals are processed to obtain the information data and to perform automatic focus and tracking control. When a focus error and a tracking error are detected from the reflected beams, focus and tracking adjustments may be performed automatically. After automatic control is performed, the optical pickup 410 may read data from, or record (write) data on, the recording layer of the optical tape 200 by laser beams.

Any conventional semiconductor laser may be used as a light source. For example, an infrared laser diode of wavelength 780 nm, a red laser diode of wavelength 650 nm, and/or a blue laser diode of wavelength 405 nm may be used for the optical pickup 410. The optical pickup 410 may include multiple laser diodes of different wavelengths and supporting optical components for compatibility with multiple standards.

It should be noted that the layers and components depicted in FIGS. 2-5 are not drawn to scale and each layer or component may be much larger or smaller in size in relation to the other layers or components. For example, the substrate 202 may be much thicker than other layers in order to provide structural rigidity and robustness.

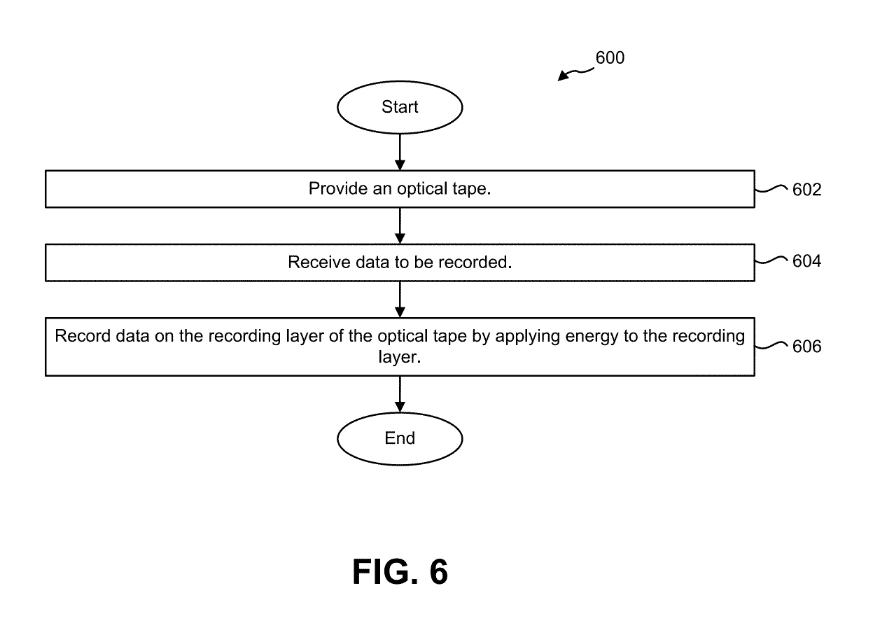

FIG. 6 shows an example process 600 of recording data on the optical tape in accordance with one embodiment. The recording process may be similar to that used in conventional optical discs, such as a CD, DVD, or BD. The process 600 will be described with reference to the components described in FIGS. 2-5. The process 600 may be carried out by a computer system. The computer system may comprise a special purpose or general purpose computer including various types of computer hardware and software.

Embodiments within the scope of the present invention include computer-readable media for carrying or having computer-executable instructions or data structures stored thereon to perform the processes in accordance with embodiments disclosed herein. Such computer-readable media can be any available media that can be accessed by a general purpose or special purpose computer. By way of example, and not limitation, such computer-readable media can comprise physical (or recordable type) computer-readable media including RAM, ROM, EEPROM, Flash memory, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. Additionally, when information is transferred or provided over a network or another communications connection (either hardwired, wireless, or a combination of hardwired or wireless) to a computer, the computer properly views the connection as a computer-readable medium. Thus, any such connection is also properly termed a computer-readable medium. Combinations of the above should also be included within the scope of computer-readable media. Computer-executable instructions comprise, for example, instructions and data which cause a general purpose computer, special purpose computer, or special purpose processing device to perform a certain function or group of functions.

Referring to FIG. 6, an optical tape is provided for recording data on the recording layer of the optical tape (602). The optical tape includes at least one substrate and at least one recording layer. Data to be recorded is received (604). The data is then recorded on the recording layer of the optical tape by applying energy to the recording layer to cause an optically detectable change in the recording layer (606). The process of recording data on the optical tape may use a laser. The laser energy would open up holes in the material of the recording layer, creating the necessary optical contrast to store data, as show in FIG. 2B.

All of the materials and/or methods and/or processes and/or apparatus disclosed and claimed herein can be made and executed without undue experimentation in light of the present disclosure. While the compositions and methods of this invention have been described in terms of preferred embodiments, it will be apparent to those of skill in the art that variations may be applied to the materials and/or methods and/or apparatus and/or processes and in the steps or in the sequence of steps of the methods described herein without departing from the concept and scope of the invention. More specifically, it will be apparent that certain materials which are both chemically and optically related may be substituted for the materials described herein while the same or similar results would be achieved. All such similar substitutes and modifications apparent to those skilled in the art are deemed to be within the scope and concept of the invention.

What is claimed is:

1. An optical tape comprising:
a substrate in a linear thin film shape; and
a recording layer deposited on the substrate, wherein an optically detectable change is formed in the recording layer upon application of energy to the recording layer such that data is recorded on the recording layer by forming irreversible optically detectable changes.

2. The optical tape of claim 1, wherein material of the recording layer is substantially inert to oxidation and has a melting point of about 200° C. to about 1,000° C. when in the form of either (a) bulk form, (b) a thin film, and/or (c) a porous or a particulate film.

3. The optical tape of claim 2, wherein after exposure of bulk material of the recording layer to air at 220° C. for 48 hours, either (a) an oxide layer does not form on the bulk material, or (b) an oxide layer forms on the bulk material that is no more than a predetermined thickness.

4. The optical tape of claim 1, wherein the recording layer comprises a metal, a metal alloy, a metal oxide, a metalloid, or any combination thereof.

5. The optical tape of claim 1, wherein the recording layer comprises a Tellurium, Selenium, Bismuth (TSB) layer sandwiched between two carbon layers.

6. The optical tape of claim 1, wherein the recording layer comprises AuSn alloy, AuSi alloy, AuGe alloy, AuIn alloy, CrO, CrO₂, VO₂, or a combination thereof.

7. The optical tape of claim 1, wherein the recording layer comprises at least one dopant.

8. The optical tape of claim 1, further comprising:
an adhesion promotion layer for improving adhesion of the recording layer and the substrate.

9. The optical tape of claim 1, further comprising:
a reflective layer for providing optical contrast to an adjacent layer.

10. The optical tape of claim 1, further comprising:
an absorptive layer positioned adjacent to the recording layer to absorb ablatable material not entirely ablated during ablation.

11. An optical tape storage device comprising:
an optical pickup device for optically wiring data on, and/or reading data from, an optical tape, wherein the data is optically stored on a recording layer of the optical tape by forming irreversible optically detectable changes in the recording layer by applying energy to the recording layer; and
a tape drive for driving the optical tape in a forward direction or a backward direction between a first reel and a second reel while the optical tape passes the optical pickup device.

12. The optical tape storage device of claim 11, wherein material of the recording layer is substantially inert to oxidation and has a melting point of about 200° C. to about 1,000° C. when in the form of either (a) bulk form, (b) a thin film, and/or (c) a porous or a particulate film.

13. The optical tape storage device of claim 12, wherein after exposure of bulk material of the recording layer to air at 220° C. for 48 hours, either (a) an oxide layer does not form on the bulk material, or (b) an oxide layer forms on the bulk material that is no more than a predetermined thickness.

14. The optical tape storage device of claim 11, wherein the recording layer comprises a metal, a metal alloy, a metal oxide, a metalloid, or any combination thereof.

15. The optical tape storage device of claim 11, wherein the recording layer comprises a Tellurium, Selenium, Bismuth (TSB) layer sandwiched between two carbon layers.

16. The optical tape storage device of claim 11, wherein the recording layer comprises AuSn alloy, AuSi alloy, AuGe alloy, AuIn alloy, CrO, CrO₂, VO₂, or a combination thereof.

17. The optical tape storage device of claim 11, wherein the recording layer comprises at least one dopant.

18. The optical tape storage device of claim 11, wherein the optical tape further comprises an adhesion promotion layer for improving adhesion of the recording layer and the substrate.

19. The optical tape storage device of claim 11, wherein the optical tape further comprises a reflective layer for providing optical contrast to an adjacent layer.

20. The optical tape storage device of claim 11, wherein the optical tape further comprises an absorptive layer positioned adjacent to the recording layer to absorb ablatable material not entirely ablated during ablation.

21. A method of recording data on an optical tape, the method comprising:
providing an optical tape for recording data on a recording layer of the optical tape, wherein the optical tape includes at least one substrate in a linear thin film shape and at least one recording layer deposited on the substrate;
receiving data to be recorded; and
recording the data on the recording layer of the optical tape by applying energy to the recording layer to cause an irreversible optically detectable change in the recording layer.

22. The method of claim 21, wherein material of the recording layer is substantially inert to oxidation and has a melting point of about 200° C. to about 1,000° C. when in the form of either (a) bulk form, (b) a thin film, and/or (c) a porous or a particulate film.

23. The method of claim 22, wherein after exposure of bulk material of the recording layer to air at 220° C. for 48 hours, either (a) an oxide layer does not form on the bulk material, or (b) an oxide layer forms on the bulk material that is no more than a predetermined thickness.

24. The method of claim 21, wherein the recording layer comprises a metal, a metal alloy, a metal oxide, a metalloid, or any combination thereof.

25. The method of claim 21, wherein the recording layer comprises a Tellurium, Selenium, Bismuth (TSB) layer sandwiched between two carbon layers.

26. The method of claim 21, wherein the recording layer comprises AuSn alloy, AuSi alloy, AuGe alloy, AuIn alloy, CrO, CrO₂, VO₂, or a combination thereof.

27. The method of claim 21, wherein the recording layer comprises at least one dopant.

28. The method of claim 21, wherein the optical tape further comprises an adhesion promotion layer for improving adhesion of the recording layer and the substrate.

29. The method of claim 21, wherein the optical tape further comprises a reflective layer for providing optical contrast to an adjacent layer.

30. The method of claim 21, wherein the optical tape further comprises an absorptive layer positioned adjacent to the recording layer to absorb ablatable material not entirely ablated during ablation.
